(19) United States
(12) Patent Application Publication
(10) Pub. No.: US 2024/0289536 A1
(43) Pub. Date: Aug. 29, 2024

(54) AGREEMENT ORCHESTRATION

(71) Applicant: DocuSign, Inc., San Francisco, CA (US)

(72) Inventor: Larry Jin, San Francisco, CA (US)

(21) Appl. No.: 18/175,915

(22) Filed: Feb. 28, 2023

(51) Int. Cl. G06F 40/166; G06F 16/93

(52) U.S. Cl. CPC G06F 40/166; G06F 16/93

(57) ABSTRACT

A document management system uses machine learning to generate electronic documents. Based on user input into a workflow for generating an electronic document, the document management system determines fields that require definition in the electronic document. The document management system predicts values for a first set of fields and inputs signals for a second set of fields into a supervised machine learning model, which is configured to output predicted values for the second set of fields. A user provides feedback on the predicted values of the second set of fields. The document management system incorporates the user's feedback into the generated electronic document, using confirmed values for each of the fields.

### TECHNICAL FIELD

The disclosure generally relates to the field of document management, and specifically to using machine learning to generate documents.

### BACKGROUND

Online document management systems can be used to create and review documents and may provide users with tools to edit, view, and execute the documents. Conventional document management systems require users to manually create and send new documents to other parties. There is a need to provide users with improved and efficient document creation processes.

### SUMMARY

A document management system determines, from a workflow for generating an electronic document, fields that require definition in the electronic document. The document management system predicts, based on user input during the workflow, values for a first set of fields. The document management system inputs, into a supervised machine learning model, signals corresponding to a second set of fields that do not intersect with the first set of fields. The document management system receives, as output from the supervised machine learning model, one or more predicted values for each field of the second set of fields. The document management system generates for display a user interface showing predicted values for the first set of fields and the second set of fields. The second set of fields are editable by a user. The document management system, in response to receiving confirmation from the user, generates the electronic document using confirmed values for each of the fields.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

FIG. 1 is a high-level block diagram of a system environment for a document management system, in accordance with an example embodiment.

FIG. 2 is a high-level block diagram of a system architecture of the document management system, in accordance with an example embodiment.

FIG. 3 illustrates training and applying a supervised machine learning model configured to predict values for fields in an electronic document based on historical workflows, in accordance with an example embodiment.

FIG. 4 illustrates an interface of the document management system for generating an electronic document based on historical workflows, in accordance with an example embodiment.

FIG. 5 illustrates an interface of the document management system for viewing the generated electronic document, in accordance with an example embodiment.

FIG. 6 illustrates an example process for generating the electronic document based on historical workflows in the document management system, in accordance with an example embodiment.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. A letter after a reference numeral, such as “120A,” indicates that the text refers specifically to the element having that particular reference numeral. A reference numeral in the text without a following letter, such as “120,” refers to any or all of the elements in the figures bearing that reference numeral.

The figures depict embodiments of the disclosed system (or method) for purposes of illustration only. One skilled in the art will readily recognize from the following description that alternative embodiments of the structures and methods illustrated herein may be employed without departing from the principles described herein.

### Document Management System Overview

A document management system enables a party (e.g., individuals, organizations, etc.) to create and send documents to one or more receiving parties for negotiation, collaborative editing, electronic execution (e.g., via electronic signatures), contract fulfilment, archival, analysis, and more. For example, the document management system allows users of the party to create, edit, review, and negotiate document content with other users and other parties of the document management system. An example document management system is further described in U.S. Pat. No. 9,634,875, issued Apr. 25, 2017, and U.S. Pat. No. 10,430,570, issued Oct. 1, 2019, which are hereby incorporated by reference in their entireties.

The system environment described herein can be implemented within the document management system, a document execution system, or any type of digital transaction management platform. It should be noted that although description may be limited in certain contexts to a particular environment, this is for the purposes of simplicity only, and in practice the principles described herein can apply more broadly to the context of any digital transaction management platform. Examples can include but are not limited to online signature systems, online document creation and management systems, collaborative document and workspace systems, online workflow management systems, multi-party communication and interaction platforms, social networking systems, marketplace and financial transaction management systems, or any suitable digital transaction management platform.

A user can set a series of actions, a workflow, for the document management system to automatically perform with respect to documents. The user may use a workflow to generate new documents. By analyzing workflows used to generate historical documents, the document management system generates content suggestions for new documents created by the user. The user provides feedback on the content suggestions, based on which the document management system retrains the machine learning model. The document management system, accordingly, provides the user with an increasingly efficient and accurate document generation and workflow process.

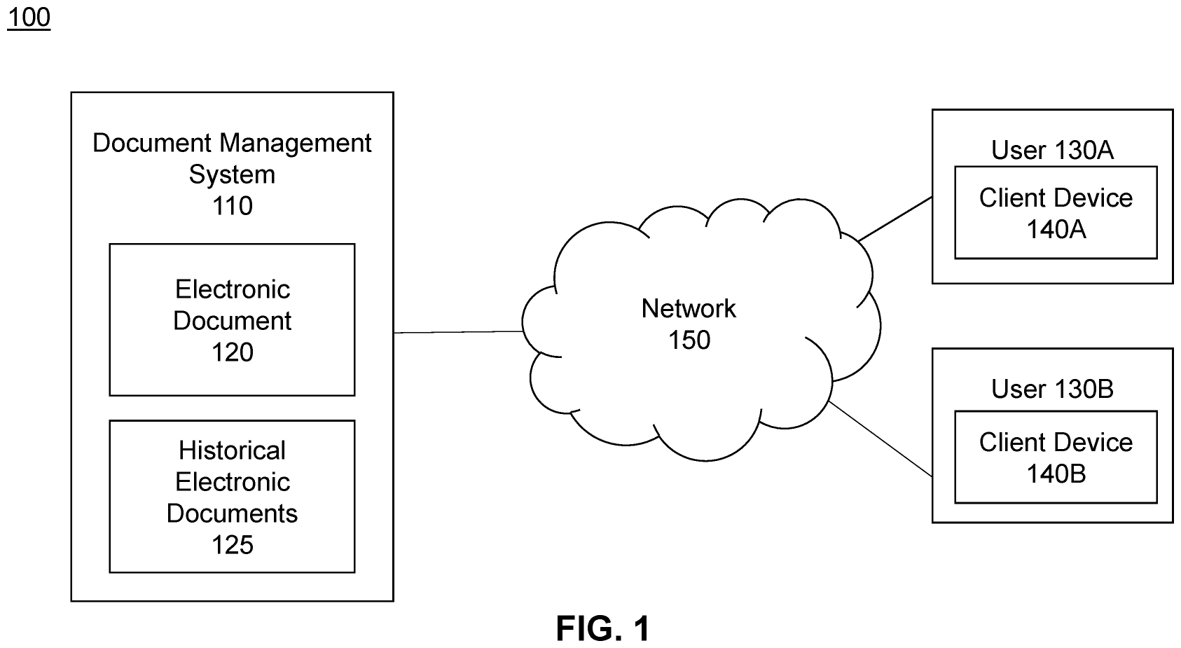

FIG. 1 is a high-level block diagram of a system environment 100 for a document management system 110, in accordance with an example embodiment. The system environment 100 enables users 130A-B to more efficiently generate documents with the document management system 110. As illustrated in FIG. 1, the system environment 100 includes a document management system 110, users 130A-B, and corresponding client devices 140A-B, each communicatively interconnected via a network 150. In some embodiments, the system environment 100 includes components other than those described herein. For clarity, although FIG. 1 only shows two users 130A-B and two client devices 140A-B, alternate embodiments of the system environment 100 can have any number of users and client devices. For the purposes of concision, the web servers, data centers, and other components associated with an online system environment are not shown in FIG. 1.

The document management system 110 is a computer system (or group of computer systems) for storing and managing documents for the users 130A-B. Using the document management system 110, users 130A-B can collaborate to create, edit, review, and negotiate documents, including an electronic document 120 and historical electronic documents 125. Examples of documents that may be stored, analyzed, and/or managed by the document management system 110 include contracts, press releases, technical specifications, employment agreements, purchase agreements, services agreements, financial agreements, and so on.

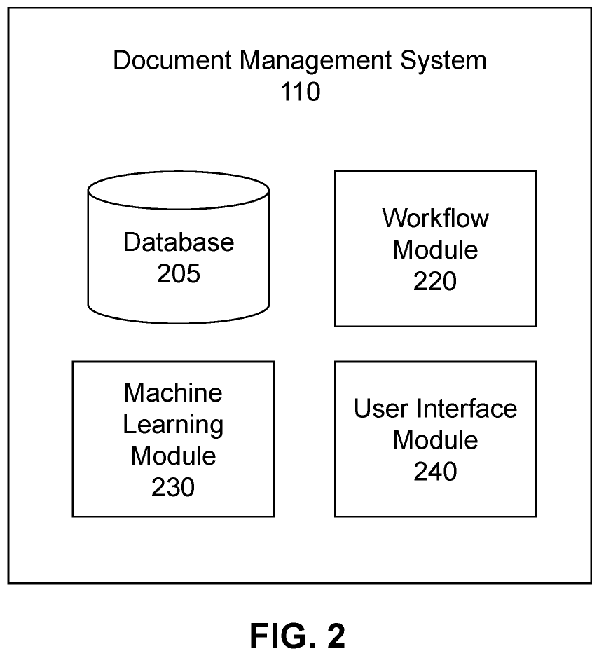

The document management system 110 can be a server, server group or cluster (including remote servers), or another suitable computing device or system of devices. In some implementations, the document management system 110 can communicate with client devices 140A-B over the network 150 to receive instructions and send documents (or other information) for viewing on client devices 140A-B. The document management system 110 can assign varying permissions to individual users 130A-B or groups of users, specifying the documents (e.g., including the historical electronic documents 125) that each user can interact with and what level of control the user has over the documents they have access to. The document management system 110 will be discussed in further detail with respect to FIG. 2.

Users 130A-B of the client devices 140A-B can perform actions relating to documents stored within the document management system 110. For example, the users 130A-B may create, edit, and/or execute the electronic document 120. Each client device 140A-B is a computing device capable of transmitting and/or receiving data over the network 150. Each client device 140A-B may be, for example, a smartphone with an operating system such as ANDROID® or APPLE® IOS®, a tablet computer, laptop computer, desktop computer, or any other type of network-enabled device from which secure documents may be accessed or otherwise interacted with. In some embodiments, the client devices 140A-B include an application through which the users 130A-B access the document management system 110. The application may be a stand-alone application downloaded by the client devices 140A-B from the document management system 110. Alternatively, the application may be accessed by way of a browser installed on the client devices 140A-B and instantiated from the document management system 110. The client devices 140A-B enables the users 130A-B to communicate with the document management system 110. For example, the client devices 140A-B enables the users 130A-B to access, review, execute, and/or analyze documents within the document management system 110 via a user interface. In some implementations, the users 130A-B can also include AIs, bots, scripts, or other automated processes set up to interact with the document management system 110 in some way. According to some embodiments, the users 130A-B are associated with permissions, which define actions users 130A-B can take within the document management system 110, or on documents, templates, permissions associated with other users and/or workflows.

An entity may direct the users 130A-B to perform the actions relating to the documents stored within the document management system 110. For example, the users 130A-B may be employed by an entity that uses the document management system 110 to generate and send contracts to various counterparties. Characteristics of these entities include a specific type (e.g., corporation, government organization, partnership, etc.), industry (e.g., medical, education, finance, technology, etc.), an associated geographic region or jurisdiction, and so on.

The network 150 transmits data within the system environment 100. The network 150 may be a local area or wide area network using wireless or wired communication systems, such as the Internet. In some embodiments, the network 150 transmits data over a single connection (e.g., a data component of a cellular signal, or Wi-Fi, among others), or over multiple connections. The network 150 may include encryption capabilities to ensure the security of customer data. For example, encryption technologies may include secure sockets layers (SSL), transport layer security (TLS), virtual private networks (VPNs), and Internet Protocol security (IPsec), among others.

FIG. 2 is a high-level block diagram of a system architecture of the document management system 110, in accordance with an example embodiment. To facilitate document generation, the document management system 110 includes a database 205, a workflow module 220, a machine learning module 230, and a user interface module 240. Computer components such as web servers, network interfaces, security functions, load balancers, failover servers, management and network operations consoles, and the like may not be shown so as to not obscure the details of the system architecture. The document management system 110 may contain more, fewer, or different components than those shown in FIG. 2 and the functionality of the components as described herein may be distributed differently from the description herein.

The database 205 stores information relevant to the document management system 110. The database 205 can be implemented on a computing system local to the document management system 110, remote or cloud-based, or using any other suitable hardware or software implementation. The data stored by the database 205 may include, but is not limited to, documents for analysis and/or execution (e.g., the electronic document 120, the historical electronic documents 125), client device identifiers (e.g., of the client devices 140A-B), document clauses, version histories, document templates, and other information about document stored by the document management system 110. In some embodiments, the database 205 stores metadata information associated with workflows, documents or clauses, and fields and values within the documents and clauses, including labeled training data for machine learning models. The document management system 110 can update information stored in database 205 as new information is received, such as new documents and feedback from users. The document management system 110 can update information stored in the database 205 based on user input received from a user interface, via the user interface module 240. Updates to machine learned models are also stored in the database 205.

The workflow module 220 allows users to specify workflows for documents (e.g., including the electronic document 120 and the historical electronic documents 125) in the document management system 110. A workflow is a series of actions, defined by the user, that the document management system 110 performs automatically with respect to a document. Examples of actions include, but are not limited to, generating a document, sending a document to another user for revision, review, and/or execution, updating a time and/or date stamp on a document, deleting the document, locking the document to preclude future edits, and so on.

When generating a document within the document management system 110, users can set different workflows for different types of documents, parties and/or entities associated with documents, authors and/or recipients of the documents, and so on. The document management system 110 will execute the appropriate set of actions based on the workflow defined by the user for a specific document. For example, a user may define a workflow such that the document management system 110 sends all legal documents associated with one entity to the entity's general counsel. In another example, the user may define an offer letter workflow. The workflow may require the document management system 110 to generate an employment offer letter, provide the document to the recipient, whose name and contact information is included in the document, and in response to detecting that the recipient has executed the document, initiate a background check (e.g., via a third party service) on the new employee. Additionally, the document management system 110 may send the background check results to the user, and upload both the signed letter and the background check results to a human resources system.

The document management system 110 may use machine learning to identify one or more workflows applicable to a generated document. For example, the user specified workflows (e.g., as described above) may be used as labeled training data for a machine learning model that is configured to output a workflow for a document of a specific type, created by a specific user, and so on.

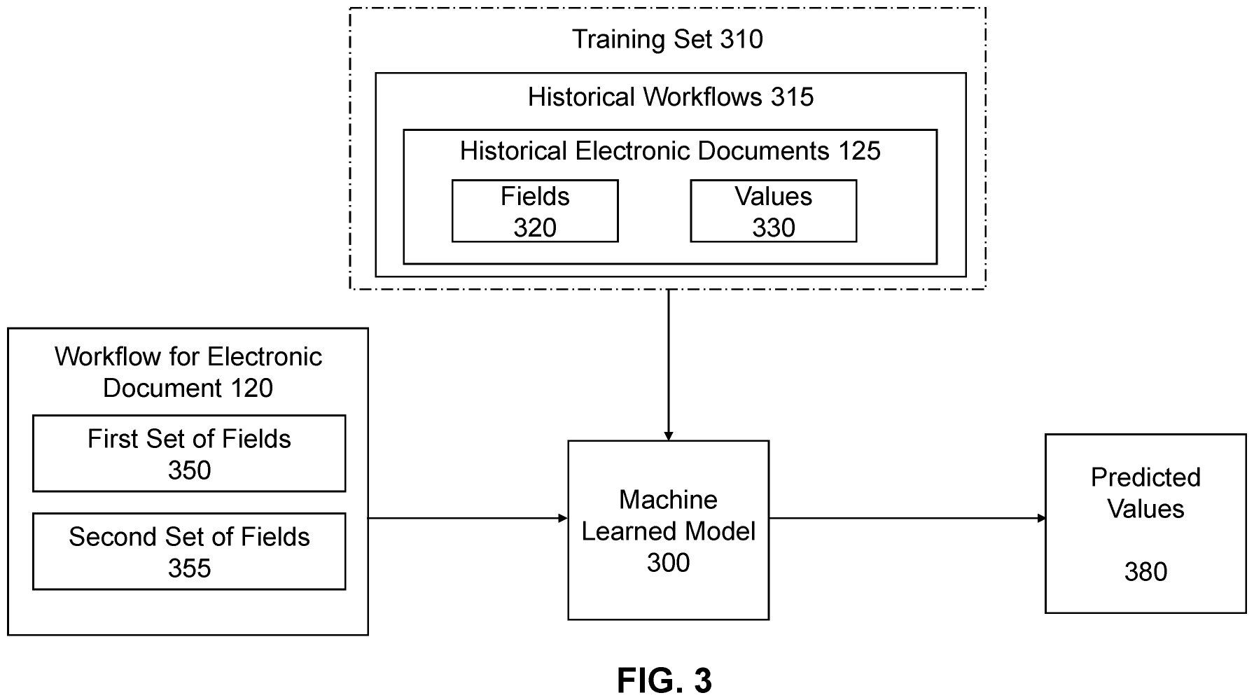

The machine learning module 230 trains and applies machine learning models within the document management system 110. The machine learning module 230 trains a machine learning model on historical workflows for generating the historical electronic documents 125. When a user seeks to generate a new document, the machine learning model suggests content for the new document, which the user can review, edit, and/or confirm. The machine learning module 230 may also include a model store, which stores various versions of the machine learning model as it is updated over time. The machine learning model is described in further detail with respect to FIG. 3.

The user interface (UI) module 240 generates user interfaces allowing users (e.g., the users 130A-B) to interact with the document management system 110. Through the UI module 240, the user may generate a new document (e.g., the electronic document 120), view suggestions on content for the document, and provide feedback on the suggested content. The UI module 240 also provides a user interface for users to add, delete, or modify the content of the generated document, preview the document, and/or finalize the document. Additionally, in some embodiments, the UI module 240 may provide a user interface that allows users to modify content such as text, images, links to outside sources of information such as databases, and the like.

### Training and Application of Supervised Machine Learning Model

FIG. 3 illustrates training and applying a supervised machine learning model 300 configured to predict values for fields in an electronic document based on historical workflows, in accordance with an example embodiment. A user of the document management system 110 may initiate a workflow for generating the electronic document 120, based on which the machine learning module 230 uses machine learning to provide content suggestions for the newly generated electronic document 120.

The machine learning module 230 uses a training set 310 to train the machine learning model 300. The training set 310 includes a number of historical workflows 315 configured to generate at least one of the historical electronic documents 125. Each historical electronic document 125 includes content, specifically fields 320 and values 330. The fields 320 are terms requiring definition, such as party names, authorized representatives of each party, dates, and/or jurisdiction. The generated historical electronic document 125 includes values 330 for each of the fields 320. In some embodiments, the training set 310 includes characteristics associated with each historical electronic document 125. These characteristics include, but are not limited to, a type of the document, users and/or entities associated with the document, characteristics of the entities associated with the document, parties to the document, and a jurisdiction associated with the document. Accordingly, the training set 310 may include historical workflows 315 specific to a type of document, a user and/or entity associated with the document, a party to the document, and so on. In another embodiment, the training set 310 is specific to a user of the document management system 110 and is limited to historical workflows 310 and historical electronic documents 125 that the user is authorized to access. Users of the document management system 110 may manually label each of the historical workflows 315, historical electronic documents 125, fields 320, and values 330 in the training set 310. The training set 310 may be stored in the database 205.

The machine learning module 230 uses the training set 310 to train the machine learning model 300. The machine learning model 300 learns to draw conclusions from relationships between the data in the training set 310, specifically between the fields 320 and values 330 and the historical workflow 315 that generated each historical electronic document 125. The machine learning model 300 may learn that historical workflows 315 output documents with a first set of consistent fields 320 and values 330, while a second set of fields 320 and values 330 may vary. For example, the machine learning model 300 may learn that one particular user generates real estate agreements (e.g., from a historical workflow 315) and that user's email address and phone number always comprise the contact information in the real estate agreements. Similarly, the machine learning model 300 may learn that all real estate agreements generated by the user are governed by the laws of California. In contrast, the machine learning model 300 may learn that the property addresses and closing dates in these generated real estate agreements vary. Accordingly, the fields for contact information and jurisdiction correspond to the first set of fields 320 and values 330, whereas the fields for property addresses and closing dates correspond to the second set of fields 320 and values 330. The machine learning model 300 may categorize the first and second set of fields 320 and values 330 based on a threshold consistency. To do so, the machine learning model 300 may determine a percentage of the historical electronic documents 125 associated with a particular historical workflow 315 that include consistent fields 320 and values 330.

In some embodiments, the machine learning model 300 may learn that third party services and/or institutions (e.g., banks, schools, government entities, healthcare clinics) provide a subset of the values 330 for the second set of fields 320. For example, a bank may provide a value 330 for a credit score field 320 in a loan document (e.g., one of the historical electronic documents 125).

The machine learning module 230 may use different versions of supervised or unsupervised machine learning, or another training technique to generate and update the machine learned model 300. In some embodiments, other training techniques may be linear support vector machines (linear SVM), boosting for other algorithms (e.g., AdaBoost), neural networks, logistic regression, naïve Bayes, memory based learning, random forests, bagged trees, decision trees, boosted trees, boosted stumps, and so on.

The workflow module 220 receives input from a user initiating a workflow for generating the electronic document 120. The trained machine learning model 300 takes, as input, the workflow for generating the electronic document 120. The input includes signals corresponding to a first set of fields 350 (e.g., fields whose values the document management system 110 can confidently predict because of consistencies in historical electronic documents 125) and the second set of fields 355 (e.g., fields whose values the document management system 110 is not confident about because of variation in the historical electronic documents 125) of the electronic document 120. In some embodiments, the user specifies each set of fields 350 and 355.

The machine learning model 300 outputs predicted values 380 for the first set of fields 350 and the second set of fields 355. For each predicted value 380, the machine learning model 300 determines a confidence score reflecting the likelihood that the user would accept the predicted value 380 in the generated electronic document 120. In some embodiments, the machine learning model 300 outputs its predicted values 380 and the corresponding confidence scores based on additional characteristics relating to the electronic document 120, including, but not limited to, characteristics of the user who initiated the workflow to generate the electronic document 120, the type of the electronic document 120, an intended recipient of the electronic document 120, a jurisdiction associated with the electronic document 120, and so on. In other embodiments, the machine learning model 300 may instruct the document management system 110 to collect information from a third party service and/or institution to provide the predicted values 380.

The user interface module 240 presents the results of the machine learning model 300, the predicted values 380 and representations of the determined confidence scores, to the user. In some embodiments, the user interface module 240 only presents the predicted values 380 and representations of the determined confidence scores corresponding to the second set of fields 355. In some embodiments, the user interface module 240 ranks the predicted values 380 based on the determined confidence scores and orders the predicted values 380 accordingly. The user may provide feedback, for example, by confirming the predicted values 380, rewriting the predicted values 380, and/or requesting the machine learning model 300 to provide a new set of predicted values 380. The confirmed set of predicted values 380 is added to the training set 310, which the machine learning module 230 uses to retrain the machine learning model 300. The document management system 110 generates the electronic document 120 based on predicted values 380 that have been confirmed by the user.

Throughout the disclosure, mention is made of forming suggested content in the form of predicted values forming suggested fields for a user to include in a document. However, while this is a prevalent illustrative example, the same principles may be applied to providing suggested content of other types, such as suggested workflows. For example, machine learned model 300 may be trained take the same inputs as described above and to output one or more predicted workflows (e.g., in addition to or instead of predicted values 380). Machine learned model 300 may be trained using the same training examples as described above, except the labels may indicate a workflow taken given the scenario of the training example. For example, where it is common to integrate an identity verification workflow, or to connect to an internal relationship management system, at the stage of the workflow where the document for which we are predicting values is involved, the suggestion of those workflows may be provided in addition to the predicted values for the fields.

### Example Interface for Document Generation

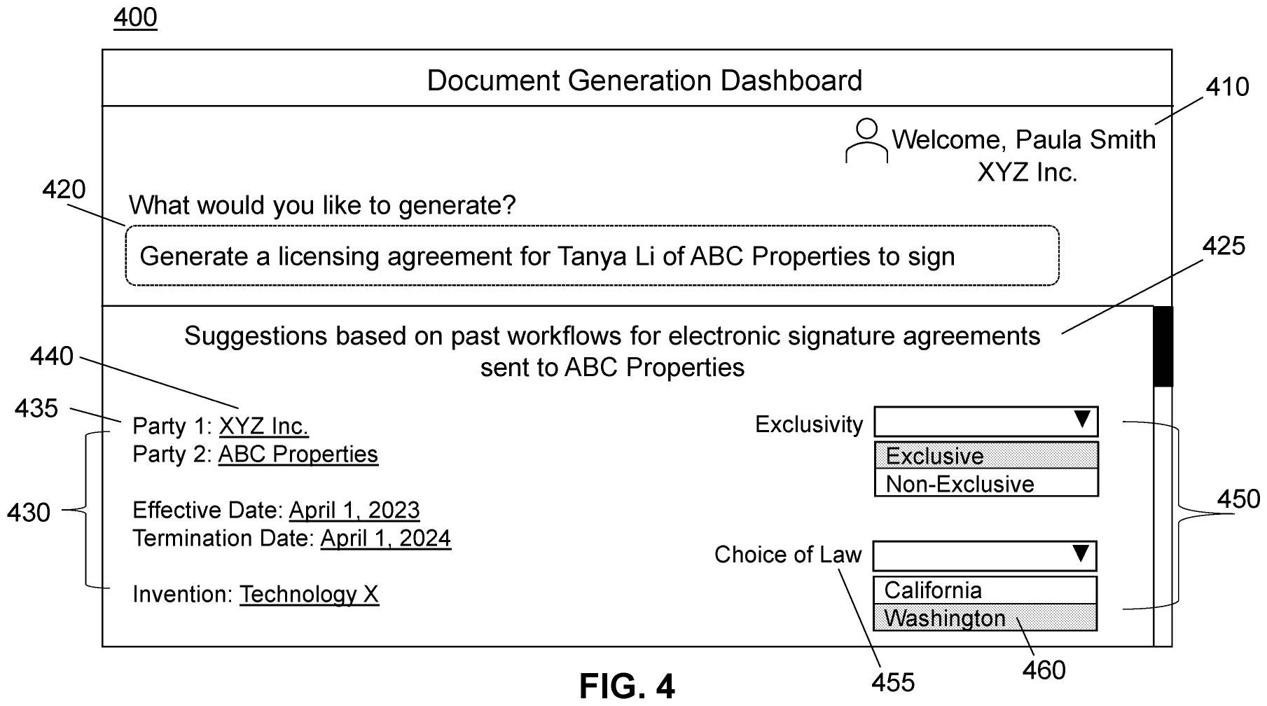

FIG. 4 illustrates an interface 400 of the document management system for generating an electronic document based on historical workflows, in accordance with an example embodiment. The document management system 110 generates the interface 400 via the user interface module 240. A user 410, Paula Smith of XYZ Inc., is logged into the document management system 110, and provides input 420 that initiates a workflow for generating a licensing agreement (e.g., the electronic document 120). The input 420 may be natural language text, as is shown in FIG. 4, or, in other embodiments, a selection of a workflow from a plurality of options. The document management system 110 generates suggestions for values (e.g., the predicted values 380, as output by the machine learning model 300) based on past historical workflows 425. In this example, the document management system 110 analyzed past historical workflows 425 that generated agreements sent to ABC Properties for execution. The interface 400 includes a first set of fields and corresponding predicted values 430. For example, the document management system 110 may determine with near certainty (e.g., likelihood above a predefined high threshold (e.g., 95%+likely)) that the field 435, “Party 1,” corresponds to the value 440 “XYZ Inc.” The user 410, however, may edit, change, and/or override any of the first set of fields and corresponding predicted values 430. The interface 400 also includes a second set of fields and a number of corresponding predicted values 450. For the field 455, “Choice of Law,” the interface 400 displays the values 460 of “California” and “Washington,” which the user 410 can select from. The user 410 may, in some embodiments, revise the presented values 450. The interface 400 may also include representations of confidence scores associated with each of the predicted values 450.

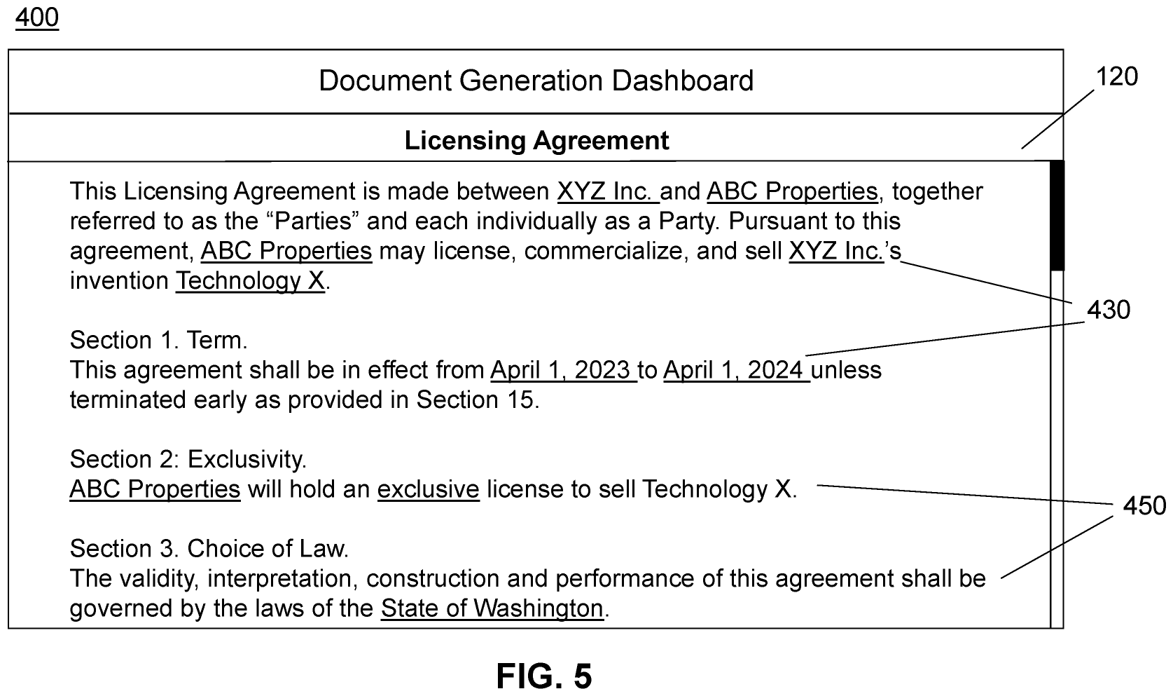

FIG. 5 illustrates an interface 400 of the document management system for viewing the generated electronic document 120, in accordance with an example embodiment. After the user 410 confirms the predicted values 450, the document management system 110 executes the workflow to generate the electronic document 120. The generated document incorporates the first set of values 430, as well as the second set of values 450 that have been confirmed by the user 410, into the generated electronic document 120. In some embodiments, the document management system 110 performs the remainder of any workflow operations on the generated electronic document 120. For example, the workflow may instruct the document management system 110 to automatically send the generated electronic document 120 to ABC Properties for execution.

### Example Process for Document Generation Using Machine Learning

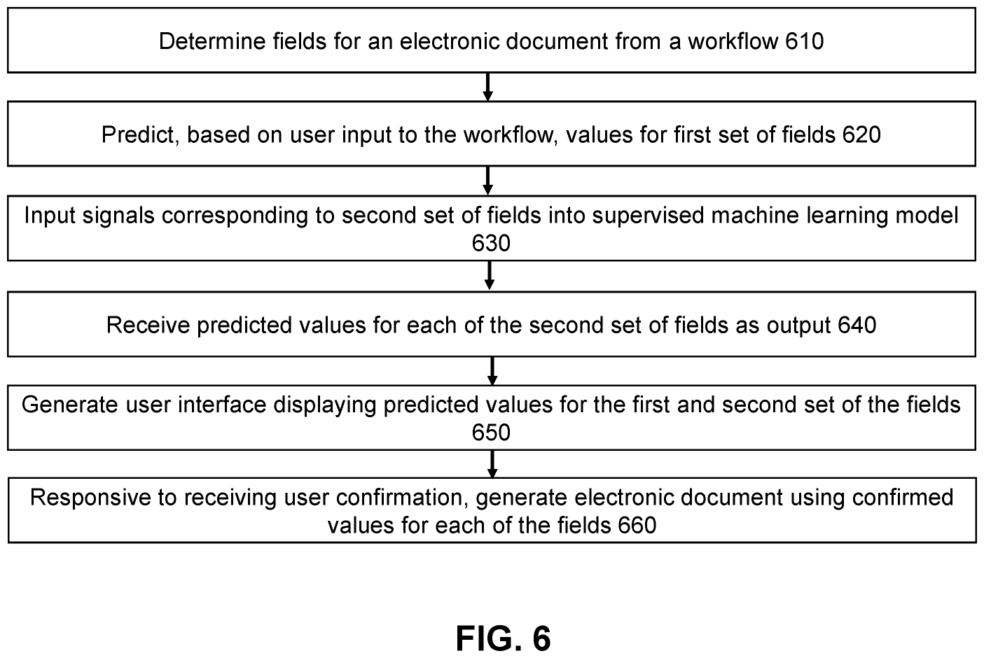

FIG. 6 illustrates an example process for generating an electronic document based on historical workflows in the document management system, in accordance with an example embodiment. From a workflow for generating an electronic document (e.g., the electronic document 120), the document management system determines 610 fields that require definition within the electronic document.

The document management system predicts 620, based on user input during the workflow, values (e.g., the predicted values 380) for a first set of the fields (e.g., the first set of fields 350).

The document management system inputs 630, into a supervised machine learning model (e.g., the machine learning model 300), signals corresponding to a second set of the fields that do not intersect with the first set of the fields (e.g., the second set of the fields 355).

The document management system receives 640 predicted values for each field of the second set of fields as output from the supervised machine learning model.

The document management system generates 650 a user interface displaying predicted values for the first set of the fields and the second set of the fields. The second set of the fields are editable by a user (e.g., the user 410).

The document management system generates 660 the electronic document in response to receiving the user's confirmation of the predicted values for the second set of the fields. The generated electronic document includes the confirmed values for each of the fields.

### Additional Configuration Considerations

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like.

Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

1. A method, comprising:
determining, from a workflow for generating an electronic document, fields that require definition in the electronic document;
predicting, based on user input during the workflow, values for a first set of the fields;
inputting, into a supervised machine learning model, instructions corresponding to a second set of the fields that do not intersect with the first set of the fields;
receiving, as output from the supervised machine learning model, one or more predicted values for each field of the second set of fields;
generating for display a user interface showing predicted values for the first set of the fields and the second set of the fields, at least the second set of the fields editable by a user, the predicted values for the first set of the fields are predicted based on a consistency among a plurality of historical documents, and the predicted values for the second set of the fields are predicted based on a variation in the plurality of historical documents at lower confidence than the predicted values for the first set of fields; and
responsive to receiving confirmation from the user, generating the electronic document using confirmed values for each of the fields.

2. The method of claim 1, wherein the supervised machine learning model is trained using a training set, the training set comprising:
historical workflows for generating electronic documents;
fields in electronic documents generated from the historical workflows; and
values for the fields.

3. The method of claim 2, wherein the historical workflows correspond to at least one of:
a type of the electronic document;
a recipient of the electronic document;
the user; and
an entity of the user.

4. The method of claim 2, wherein the training set corresponds to the user, the user having permission to access the historical workflows and electronic documents generated from the historical workflows.

5. The method of claim 2, further comprising determining the instructions corresponding to the second set of the fields based on variance of the fields in the electronic documents generated from the historical workflows in the training set.

6. The method of claim 1, further comprising receiving the instructions corresponding to the second set of fields as input from the user.

7. The method of claim 1, further comprising:
for each field of the second set of fields, determining a confidence score for each predicted value; and
displaying, via the user interface, a representation of the determined confidence score.

8. The method of claim 7, further comprising:
for a subset of the second set of fields, receiving input from the user for each predicted value; and
generating the electronic document using the received input from the user.

9. The method of claim 8, further comprising training the supervised machine learning model based on the received input from the user.

10. The method of claim 1, wherein the user input during the workflow comprises a selection of a series of actions corresponding to the electronic document.

11. A non-transitory computer-readable storage medium storing executable instructions that, when executed by a hardware processor, cause the hardware processor to:
determine, from a workflow for generating an electronic document, fields that require definition in the electronic document;
predict, based on user input during the workflow, values for a first set of the fields;
input, into a supervised machine learning model, instructions corresponding to a second set of the fields that do not intersect with the first set of the fields;
receive, as output from the supervised machine learning model, one or more predicted values for each field of the second set of fields;
generate for display a user interface showing predicted values for the first set of the fields and the second set of the fields, at least the second set of the fields editable by a user, the predicted values for the first set of the fields are predicted based on a consistency among a plurality of historical documents, and the predicted values for the second set of the fields are predicted based on a variation in the plurality of historical documents at lower confidence than the predicted values for the first set of fields; and
responsive to receiving confirmation from the user, generate the electronic document using confirmed values for each of the fields.

12. The non-transitory computer-readable storage medium of claim 11, wherein the supervised machine learning model is trained using a training set, the training set comprising:
historical workflows for generating electronic documents;
fields in electronic documents generated from the historical workflows; and
values for the fields.

13. The non-transitory computer-readable storage medium of claim 12, wherein the historical workflows correspond to at least one of:
a type of the electronic document;
a recipient of the electronic document;
the user; and
an entity of the user.

14. The non-transitory computer-readable storage medium of claim 12, wherein the training set corresponds to the user, the user having permission to access the historical workflows and electronic documents generated from the historical workflows.

15. The non-transitory computer-readable storage medium of claim 12, wherein the hardware processor is configured to determine the instructions corresponding to the second set of the fields based on variance of the fields in the electronic documents generated from the historical workflows in the training set.

16. The non-transitory computer-readable storage medium of claim 11, wherein the hardware processor is configured to receive the instructions corresponding to the second set of fields as input from the user.

17. The non-transitory computer-readable storage medium of claim 11, wherein the hardware processor is configured to:
for each field of the second set of fields, determine a confidence score for each predicted value; and
display, via the user interface, a representation of the determined confidence score.

18. The non-transitory computer-readable storage medium of claim 17, wherein the hardware processor is configured to:
for a subset of the second set of fields, receive input from the user for each predicted value; and
generate the electronic document using the received input from the user.

19. The non-transitory computer-readable storage medium of claim 18, wherein the hardware processor is configured to train the supervised machine learning model based on the received input from the user.

20. A document management system, comprising:
a hardware processor; and
a non-transitory computer-readable storage medium storing executable instructions that, when executed, cause the hardware processor to:
determine, from a workflow for generating an electronic document, fields that require definition in the electronic document;
predict, based on user input during the workflow, values for a first set of the fields;
input, into a supervised machine learning model, signals instructions corresponding to a second set of the fields that do not intersect with the first set of the fields;
receive, as output from the supervised machine learning model, one or more predicted values for each field of the second set of fields;
generate for display a user interface showing predicted values for the first set of the fields and the second set of the fields, at least the second set of the fields editable by a user, the predicted values for the first set of the fields are predicted based on a consistency among a plurality of historical documents, and the predicted values for the second set of the fields are predicted based on a variation in the plurality of historical documents at lower confidence than the predicted values for the first set of fields; and
responsive to receiving confirmation from the user, generate the electronic document using confirmed values for each of the fields.
